(19) United States
(12) Patent Application Publication
(10) Pub. No.: US 2018/0164989 A1
(43) Pub. Date: Jun. 14, 2018

(54) DISPLAY OF CALENDAR EVENTS IN AN ELECTRONIC CALENDAR

(71) Applicant: SAP SE, Walldorf (DE)

(72) Inventor: CHINMAYA SARANGI, Sunnyvale, CA (US)

(21) Appl. No.: 15/377,993

(22) Filed: Dec. 13, 2016

(51) Int. Cl. G06F 3/0484; G06F 17/24; G06Q 10/10

(52) U.S. Cl. CPC G06F 3/04845; G06Q 10/1095; G06F 17/246

(57) ABSTRACT

Various embodiments of systems, computer program products, and methods to display calendar events in an electronic calendar are described herein. In an aspect, a calendar view of an electronic calendar, a calendar view setting and a number of calendar events associated with a the calendar units of the calendar view are retrieved. Further, dimensions for the calendar units are determined based on the calendar view, the calendar view setting and the number of calendar events associated with the calendar units. Based on the determined dimensions, visualization of the electronic calendar is generated. Further, the visualization of the electronic calendar is rendered to display the calendar events associated with the calendar units.

### BACKGROUND

Electronic calendar applications may provide calendar views allowing a user to view calendar information corresponding to a certain date range, for example, a “week” view, a “month” view, a “year” view and so on. The electronic calendar applications may also allow the user to view information of calendar events such as appointments, meetings, telephone conferences, and the like. In electronic calendars, some dates/days may include more calendar events compared to other dates/days, and some dates/days may not include any calendar event. To display multiple calendar events corresponding to a date/day, an additional action (e.g., an extra click or touch) may be needed to view the calendar events that are outside the default display area. Further, the calendar events may be viewed based on priority (e.g., upcoming hours, days, weeks, months and years).

### BRIEF DESCRIPTION OF THE DRAWINGS

Embodiments are illustrated by way of examples and not by way of limitation in the figures of the accompanying drawings in which like references indicate similar elements. The embodiments may be best understood from the following detailed description taken in conjunction with the accompanying drawings.

FIG. 1 is a block diagram illustrating a computing environment to display calendar events in an electronic calendar, according to an embodiment.

FIG. 2 is a flow diagram illustrating an example process to display calendar events in an electronic calendar, according to an embodiment.

FIG. 3 shows an exemplary layout of an electronic calendar, according to an embodiment.

FIG. 4 shows an exemplary layout of an electronic calendar, according to an embodiment.

FIG. 5 is a block diagram illustrating an example computer system, according to an embodiment.

### DETAILED DESCRIPTION

Embodiments of techniques to display calendar events in an electronic calendar are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instance, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In this document, various methods, processes and procedures are detailed. Although particular steps may be described in a certain sequence, such sequence may be mainly for convenience and clarity. A particular step may be repeated more than once, may occur before or after other steps (even if those steps are otherwise described in another sequence), and may occur in parallel with other steps. Further, a step may be executed upon executing another step. Such a situation may be specifically pointed out when not clear from the context. A particular step may be omitted. Further, it is to be understood that the various actions (retrieving, determining, generating, rendering, and so on) may be performed by a hardware device (e.g., computing system), even if the action may be authorized, initiated or triggered by a user, or even if the hardware device is controlled by a computer program, software, firmware, and the like.

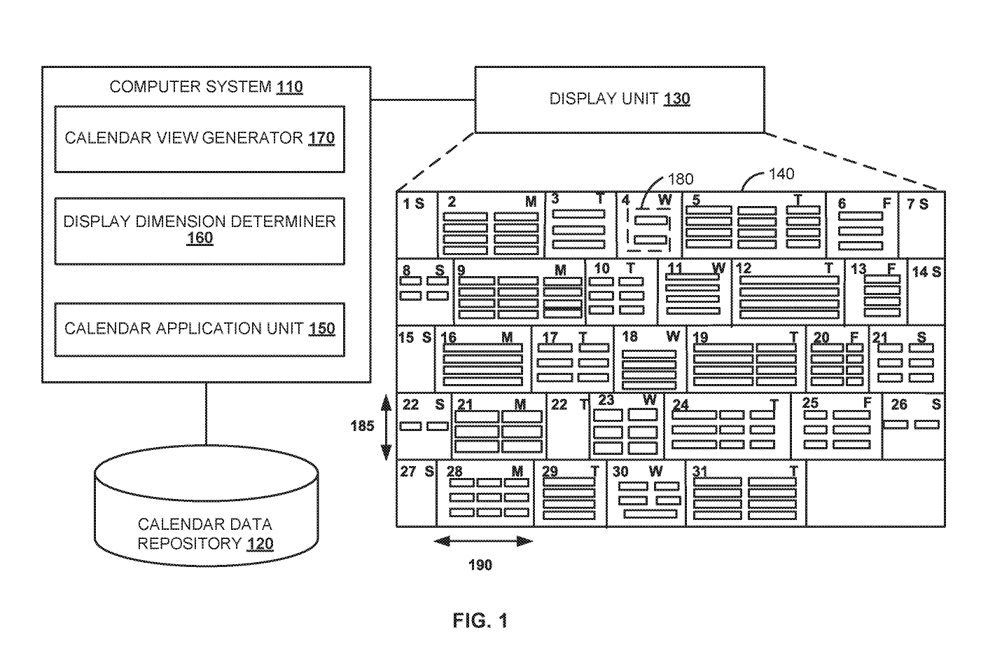

FIG. 1 is a block diagram illustrating a computing environment to display calendar events (e.g., 180) in an electronic calendar (e.g., 140), according to an embodiment. The computing environment may include computer system 110 connected to calendar data repository 120 and display unit 130. The display unit 130 may include a graphical user interface (GUI) to display an electronic calendar 140. As shown in FIG. 1, the electronic calendar 140 may include calendar events 180 such as, but are not limited to appointments, meetings and out of office notices associated with a user. The calendar events 180 associated with users may be stored in the calendar data repository 120, for instance.

The electronic calendar 140 includes calendar units defining a number of rows and a number of columns of a calendar view representing dates of the electronic calendar 140. For example, a calendar unit may represent a date/day of the electronic calendar 140. The calendar view may define date range of the electronic calendar 140 such as a week view, a month view, a bimonthly view, a year view and so on. For example, the calendar view of the electronic calendar 140 is a month view having 31 days.

In one embodiment, the computer system 110 may include components to determine dimensions of the calendar units associated with the electronic calendar 140 to display the calendar events 180. The components of the computer system 110 may include calendar application unit 150, display dimension determiner 160 and calendar view generator 170. The calendar application unit 150 may retrieve calendar information associated with a user such as the calendar view of the electronic calendar 140, a calendar view setting and calendar events 180 associated with the calendar units of the calendar view. The calendar view setting may include a fixed height of the calendar units and/or a fixed width of the calendar units.

For example, when the fixed height of the calendar units is selected, the height of the calendar units is kept constant/equal and the width of one or more of the calendar units may vary to display the associated calendar events 180. When the fixed width of the calendar units is selected, the width of the calendar units is kept constant/equal while the height of one or more calendar units may vary to display the associated calendar events 180. In one embodiment, the calendar view setting may include an option to vary both heights and widths of the electronic calendar 140. When such an option is selected, both heights and widths of the electronic calendar 140 are varied to display the calendar events associated with corresponding calendar units. In the example shown in FIG. 1, the calendar view setting includes fixed height of the calendar units, where the height (e.g., 185) of the calendar units is kept constant and the width (e.g., 190) of at least some of the calendar units varies.

In one embodiment, the display dimension determiner 160 may determine dimensions for the calendar units based on the calendar view, the calendar view setting and the number of calendar events 180 associated with the calendar units. In one example, when the calendar view is set as the fixed height of the calendar units, the dimensions for the calendar units are determined by dividing the horizontal size of the electronic calendar corresponding to the calendar units (e.g., per row) based on the number of calendar events 180 associated with the corresponding calendar units. In other words, the height of the calendar units is fixed and the width of the calendar units vary based on the number of calendar events associated per calendar unit per row. Therefore, when a calendar unit does not include any calendar events, a minimum width is assigned. When the calendar unit includes one or more calendar events, a bigger width may be assigned.

In one example, when the calendar view setting is set as the fixed width of the calendar units, the dimensions for the calendar units are determined by dividing vertical size of the electronic calendar 140 corresponding to the calendar units (e.g., per column) based on the number of calendar events associated with the corresponding calendar units. In other words, the width of the calendar units is fixed and the height of calendar units vary based on the number of calendar events associated per calendar unit per column. Therefore, when the calendar unit does not include any calendar events, a minimum height is assigned. When the calendar unit includes one or more calendar events, a bigger height is assigned. In one embodiment, both heights and widths of the electronic calendar 140 can vary to display the calendar events associated with corresponding calendar units. Example electronic calendar 140 described herein may reduce blank space in the electronic calendar 140 to display the associated calendar events 180. Thereby, electively unitizing space provided in the electronic calendar 140.

In one embodiment, the calendar view generator 170 generates visualization of the electronic calendar 140 based on the dimensions that are determined by the display dimension determiner 160. Further, the visualization of the electronic calendar 140 is rendered to display the calendar events 180 associated with the calendar units. Therefore, the electronic calendar 140 may display information or the calendar events 180 without asking the user to perform an extra action (e.g., a click or touch) on the GUI.

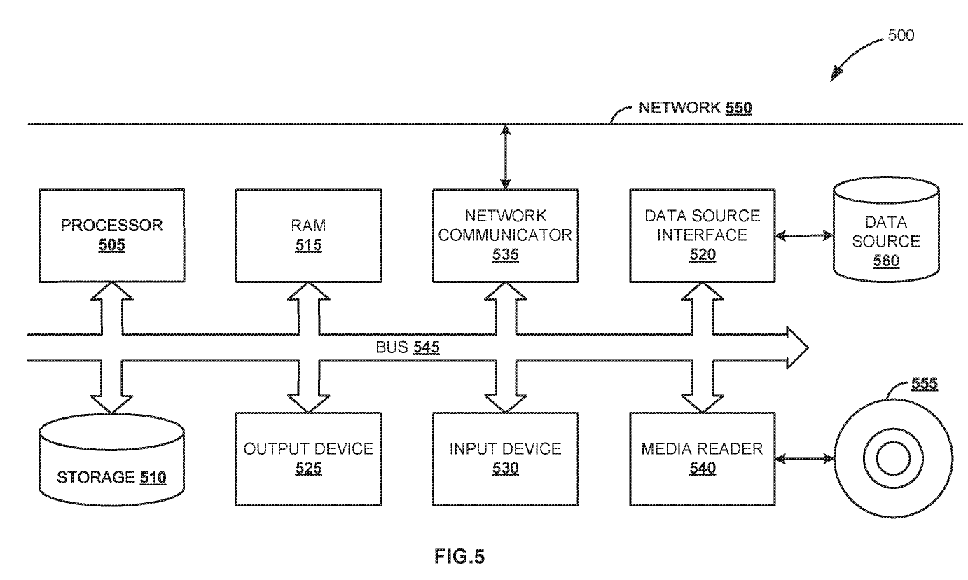

In one example embodiment, the components (e.g., the calendar application unit 150, the display dimension determiner 160 and the calendar view generator 170) can be included in the computer system 110 and/or in different computer systems. Further, the calendar application unit 150, the display dimension determiner 160 and the calendar view generator 170 may be implemented as engines or modules including any combination of hardware and programming to implement the functionalities described herein. As will be further described with respect to FIG. 5, the computer system can include one or more processors. For example, the computer system can be a computer, server, workstation, mobile device, embedded system or other device having at least one processor and memory. The computer system can include a communication port or input/output device for communicating over wired or wireless communications.

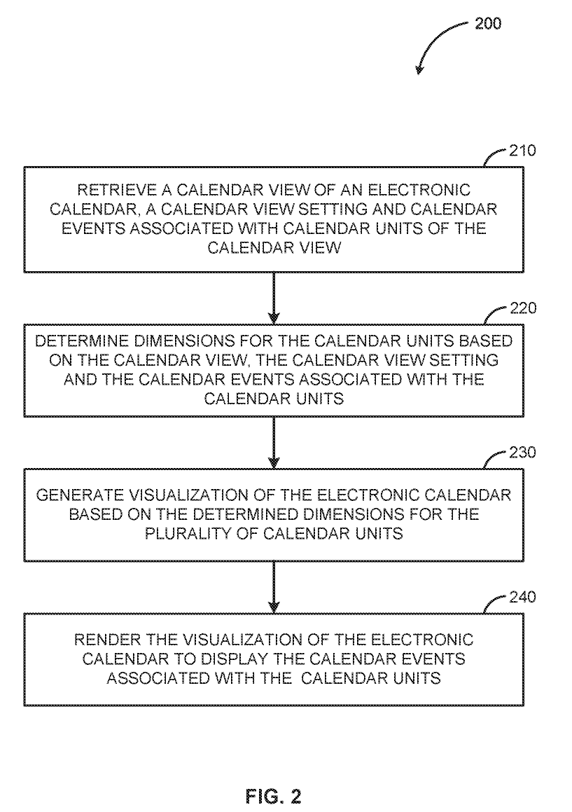

FIG. 2 is a flow diagram illustrating example process 200 to display calendar events in an electronic calendar, according to an embodiment. At 210, a calendar view of an electronic calendar, a calendar view setting and calendar events associated with calendar units of the calendar view are retrieved. The calendar units are defined by a number of rows and a number of columns of the calendar view to represent date or day of the electronic calendar. The calendar view setting may include a fixed height of the calendar units (e.g., row based) and/or a fixed width of the calendar units (e.g., column based). Through the calendar view settings, a user can read the calendar units (e.g., days) from left to right and from top to bottom, for instance. In one embodiment, the calendar view and the calendar view setting are selected by the user. For example, the user selects the calendar view (e.g., a week view, a month view, a bimonthly view, a year view and the like) and also the calendar view setting (e.g., fixed height of the calendar units and/or fixed width of the calendar units).

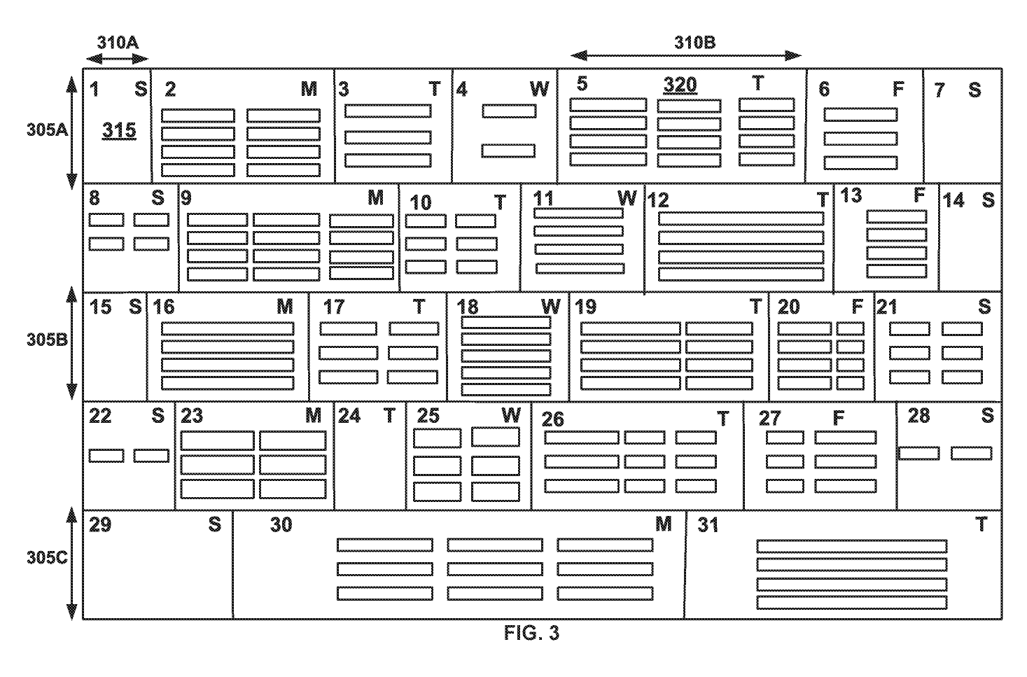

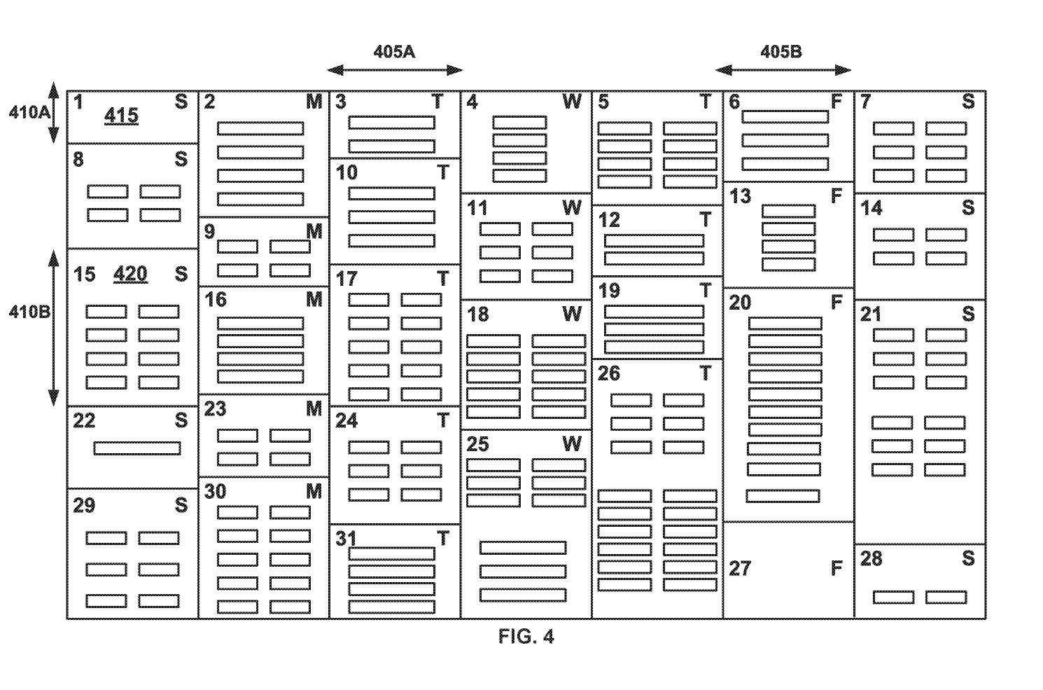

At 220, dimensions for the calendar units are determined based on the calendar view, the calendar view setting and the calendar events associated with the calendar units. In one example, when the calendar view setting is set as the fixed height of the calendar units, the dimensions for the calendar units are determined by dividing horizontal size of the electronic calendar corresponding to the calendar units based on the calendar events associated with the corresponding calendar units. An example of the electronic calendar with fixed height of the calendar units is shown in FIG. 3. In another example, when the calendar view setting includes the fixed width of the calendar units, the dimensions for the calendar units are determined by dividing vertical size of the electronic calendar corresponding to the calendar units based on the calendar events associated with the corresponding calendar units. An example of the electronic calendar with fixed width of the calendar units is shown in FIG. 4. In yet another example, when the calendar view setting is set as varying both heights and widths of the electronic calendar, the dimensions for the calendar units are determined by dividing both horizontal size and the vertical size of the electronic calendar corresponding to the calendar units based on the calendar events associated with the corresponding calendar units. In one embodiment, the determined dimensions for the calendar units can be modified based on different display sizes of display units.

At 230, visualization of the electronic calendar is generated based on the determined dimensions for the calendar units. Since the dimensions of the calendar units are determined based on calendar events associated with the calendar units, the dimensions of the calendar units can be minimized when the calendar units include less number of calendar events compared to other calendar units or no calendar events. Further, the dimensions of the calendar units can be maximized when the calendar units include more number of calendar events compared to other calendar units. At 240, the generated visualization of the electronic calendar is rendered to display calendar events associated with the calendar units.

FIG. 3 shows an exemplary layout of an electronic calendar, according to an embodiment. In the example shown in FIG. 3, calendar view is a month view and calendar view setting includes a fixed height of the calendar units (e.g., 315 and 320). In one embodiment, dimensions for the calendar units (e.g., 315 and 320) are determined based on the calendar view, the calendar view setting and the number of calendar events associated with the calendar units. In the example, a total horizontal size (e.g., width of the electronic calendar) of the electronic calendar is considered. Further, for each row (e.g., row 1: day 1 to day 7, row 2: day 8 to day 14, row 3: day 15 to day 21, row 4: day 22 to day 28 and row 5: day 29 to day 31) of the electronic calendar, a total number of calendar events for the days in the row is considered. Based on the considered information, the dimensions of the calendar units associated with the row may be determined.

In the example, the electronic calendar (e.g., the month view) including the calendar units (e.g., 315 and 320) are displayed. Further, the electronic calendar includes calendar events associated with the calendar units based on determined dimensions for the calendar units (e.g., 315 and 320). The calendar units (e.g., 315 and 320) represents days of the month having 31 days. For example, numbers (e.g., 1 to 31) of each calendar unit represent dates and alphabets (e.g., S-Sunday, M-Monday. T-Tuesday, W-Wednesday, T-Thursday. F-Friday and S-Saturday) represent days of the month. Further, blocks in the calendar units represent the calendar events associated with the calendar units.

For example, the calendar view setting is set as the fixed height of the calendar units, the height (e.g., 305A, 305B and 305C) of the calendar units is assigned same dimension based on the vertical size of the electronic calendar. Further, horizontal size of the electronic calendar is divided based on a number of calendar events associated with the calendar units per row. For instance, the width (e.g., 310A) of the calendar unit 315 is assigned minimum space as there are no calendar event associated with the calendar unit 315. Further, the width (310B) of the calendar unit 320 is assigned bigger space in the row (e.g., from day 1 to day 7) as the calendar unit 320 is associated with maximum number of calendar events. Similarly, dimensions of other calendar units in the row (e.g., from day 1 to day 7) are assigned based on the number of calendar events associated with the calendar units.

FIG. 4 shows an exemplary layout of an electronic calendar, according to an embodiment. In the example shown in FIG. 4, calendar view is a month view and calendar view setting includes a fixed width of the calendar units (e.g., 415 and 420). In one embodiment, dimensions for the calendar units (e.g., 415 and 420) are determined based on the calendar view, the calendar view setting and the number of calendar events associated with the calendar units. In the example, a total vertical size (e.g., height of the electronic calendar) of the electronic calendar is considered. Further, for each column (e.g., column 1: 1, 8, 15, 22 and 29 days; column 2: 2, 9, 16, 23 and 30 days; column 3: 3, 10, 17, 24 and 31 days; column 4: 4, 11, 18 and 25 days; column 5: 5, 12, 19 and 26 days; column 6: 6, 13, 20 and 27 days; and column 7: 7, 14, 21 and 28 days) of the electronic calendar, a total number of calendar events for the days in the column are considered. Based on the considered information, the dimensions of the calendar units may be determined.

In the example, the electronic calendar (e.g., the month view) including the calendar units (e.g., 415 and 420) are displayed. Further, the electronic calendar includes calendar events associated with the calendar units based on determined dimensions for the calendar units (e.g., 415 and 420). The calendar units (e.g., 415 and 420) represents days of the month having 31 days. For example, numbers (e.g., 1 to 31) each calendar unit represent dates and alphabets (e.g., S-Sunday, M-Monday. T-Tuesday, W-Wednesday, T-Thursday, F-Friday and S-Saturday) represent days of the month. Further, blocks in the calendar units represent the calendar events associated with the calendar units.

For example, the calendar view setting is set as the fixed width of the calendar units, the width (e.g., 405A and 405B) of the calendar units is assigned same dimension based on the horizontal size of the electronic calendar. Further, vertical size of the electronic calendar is divided per calendar unit based on the number of calendar events associated with the calendar units per column. For instance, the height (e.g., 410A) of the calendar unit 415 is assigned minimum space and the height (e.g., 410B) of the calendar unit 420 is assigned bigger space in the column (e.g., column 1: 1, 8, 15, 22 and 29 days). Similarly, dimensions of other calendar units in the column (e.g., column 1: 1, 8, 15, 22 and 29 days) are assigned based on the number of calendar events associated with the calendar units.

Some embodiments may include the above-described methods being written as one or more software components. These components, and the functionality associated with them, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” includes a single medium or multiple media that stores one or more sets of instructions. The term “computer readable storage medium” includes physical article that is capable of undergoing a set of physical changes to physically store, encode, or otherwise carry a set of instructions for execution by a computer system which causes the computer system to perform the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

FIG. 5 is a block diagram of example computer system 500, according to an embodiment. The computer system 500 includes a processor 505 that executes software instructions or code stored on a computer readable storage medium 555 to perform the above-illustrated methods. The processor 505 can include cores. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. According to some embodiments, such as some in-memory computing system embodiments, the RAM 515 can have sufficient storage capacity to store much of the data required for processing in the RAM 515 instead of in the storage 510. In some embodiments, the data required for processing may be stored in the RAM 515. The stored instructions may be further compiled to generate other representations of the instructions and dynamically stored in the RAM 515. The processor 505 reads instructions from the RAM 515 and performs actions as instructed. According to one embodiment, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. One or more of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments, the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a number of reports, and any other data source accessible through an established protocol, such as, Open Database Connectivity (ODBC), produced by an underlying software system, e.g., an enterprise resource planning (ERP) system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. A non-transitory computer readable storage medium storing instructions, which when executed by a computer cause the computer to:
retrieve a calendar view of an electronic calendar, a calendar view setting and a plurality of calendar events associated with a plurality of calendar units of the calendar view;
determine dimensions for the plurality of calendar units based on the calendar view, calendar view setting and the plurality of calendar events associated with the plurality of calendar units;
generate visualization of the electronic calendar based on the determined dimensions for the plurality of calendar units; and
render the generated visualization of the electronic calendar to display the plurality of calendar events associated with the plurality of calendar units.

2. The non-transitory computer-readable medium of claim 1, wherein the plurality of calendar units are defined by a plurality of rows and a plurality of columns of the calendar view.

3. The non-transitory computer-readable medium of claim 1, wherein the calendar view setting comprises one of a fixed height of the plurality of calendar units, a fixed width of the plurality of calendar units, and varying heights and widths of the plurality of calendar units.

4. The non-transitory computer-readable medium of claim 1, further comprises instructions, which when executed by the computer cause the computer to: modify the determined dimensions for the plurality of calendar units based on different display sizes of display units.

5. The non-transitory computer-readable medium of claim 3, wherein when the calendar view setting is set as the fixed height of the plurality of calendar units, the dimensions for the plurality of calendar units are determined by dividing horizontal size of the electronic calendar corresponding to the plurality of calendar units based on the plurality of calendar events associated with the corresponding plurality of calendar units.

6. The non-transitory computer-readable medium of claim 3, wherein when the calendar view setting is set as the fixed width of the plurality of calendar units, the dimensions for the plurality of calendar units are determined by dividing vertical size of the electronic calendar corresponding to the plurality of calendar units based on the plurality of calendar events associated with the corresponding plurality of calendar units.

7. The non-transitory computer-readable medium of claim 3, wherein when the calendar view setting is set as varying heights and widths of the plurality of calendar units, the dimensions for the plurality of calendar units are determined by dividing horizontal size and vertical size of the electronic calendar corresponding to the plurality of calendar units based on the plurality of calendar events associated with the corresponding plurality of calendar units.

8. A computer implemented method to display calendar events in an electronic calendar, comprising:
retrieving, at a calendar application unit, a calendar view of the electronic calendar, a calendar view setting and a plurality of calendar events associated with a plurality of calendar units of the calendar view;
determining, at a display dimension determiner, dimensions for the plurality of calendar units based on the calendar view, the calendar view setting and the plurality of calendar events associated with the plurality of calendar units;
generating, at a calendar view generator, visualization of the electronic calendar based on the determined dimensions for the plurality of the calendar units, and
displaying, on a graphical user interface, the visualization of the electronic calendar to display the calendar events associated with the plurality of calendar units.

9. The computer implemented method of claim 8, wherein the plurality of calendar units are defined by a plurality of rows and a plurality of columns of the calendar view.

10. The computer implemented method of claim 8, wherein the calendar view setting comprises one of a fixed height of the plurality of calendar units and a fixed width of the plurality of calendar units, and varying heights and widths of the plurality of calendar units.

11. The computer implemented method of claim 8, further comprising modifying the determined dimensions for the plurality of calendar units based on different display sizes of display units.

12. The computer implemented method of claim 10, wherein when the calendar view setting is set as the fixed height of the plurality of calendar units, the dimensions for the plurality of calendar units are determined by dividing horizontal size of the electronic calendar corresponding to the plurality of calendar units based on the plurality of calendar events associated with the corresponding plurality of calendar units.

13. The computer implemented method of claim 10, wherein when the calendar view setting is set as the fixed width of the plurality of calendar units, the dimensions for the plurality of calendar units are determined by dividing vertical size of the electronic calendar corresponding to the plurality of calendar units based on the plurality of calendar events associated with the corresponding plurality of calendar units.

14. The computer implemented method of claim 10, wherein when the calendar view setting is set as varying heights and widths of the plurality of calendar units, the dimensions for the plurality of calendar units are determined by dividing horizontal size and vertical size of the electronic calendar corresponding to the plurality of calendar units based on the plurality of calendar events associated with the corresponding plurality of calendar units.

15. A computing system comprising:
at least one processor; and
one or more memory devices communicative with the at least one processor, wherein the one or more memory devices store instructions to provide a graphical user interface displayable on a computing system, the graphical user interface comprising:
an electronic calendar including a plurality of calendar units; and
a plurality of calendar events associated with the plurality of calendar units based on determination of dimensions for the plurality of calendar units.

16. The computing system of claim 15, wherein the dimensions for the plurality of calendar units are determined based on a calendar view, a calendar view setting and the plurality of calendar events associated with the plurality of calendar units.

17. The computing system of claim 16, wherein the calendar view setting comprises one of a fixed height of the plurality of calendar units, a fixed width of the plurality of calendar units, and varying heights and widths of the plurality of calendar units.

18. The computing system of claim 17, wherein when the calendar view setting is set as the fixed height of the plurality of calendar units, the dimensions for the plurality of calendar units are determined by dividing horizontal size of the electronic calendar corresponding to the plurality of calendar units based on the plurality of calendar events associated with the corresponding plurality of calendar units.

19. The computing system of claim 17, wherein when the calendar view setting includes the fixed width of the plurality of calendar units, the dimensions for the plurality of calendar units are determined by dividing vertical size of the electronic calendar corresponding to the plurality of calendar units based on the plurality of calendar events associated with the corresponding plurality of calendar units.

20. The computing system of claim 17, wherein when the calendar view setting is set as varying heights and widths of the plurality of calendar units, the dimensions for the plurality of calendar units are determined by dividing horizontal size and vertical size of the electronic calendar corresponding to the plurality of calendar units based on the plurality of calendar events associated with the corresponding plurality of calendar units.
